(19) United States
(12) Patent Application Publication
(10) Pub. No.: US 2016/0052112 A1
(43) Pub. Date: Feb. 25, 2016

(54) Illuminated Ratchet Wrench

(71) Applicant: Bryce Lemley, JR., Mcminnville, OR (US)

(72) Inventor: Bryce Lemley, JR., Mcminnville, OR (US)

(21) Appl. No.: 14/742,844

(22) Filed: Jun. 18, 2015

Related U.S. Application Data
(60) Provisional application No. 62/038,987, filed on Aug. 19, 2014.

(51) Int. Cl. B25B 23/18; F21V 33/00; B25B 13/46

(52) U.S. Cl. CPC B25B 23/18; B25B 13/46; F21V 33/0084; F21Y 2101/02

(57) ABSTRACT

An illuminated ratchet wrench having lights thereon. The illuminated ratchet wrench includes an elongated handle having a tool head on an end thereof. The tool head has a front surface on which a socket head adapted to receive a socket is positioned. Thus, the ratchet wrench operates similarly to a traditional ratchet wrench. The front surface of the tool head comprises one or more pairs of lights arranged thereon. The lights are arranged on the lower end of the tool head and are oriented in the same direction as the socket head. In this way, the lights illuminate the area in which the ratchet wrench will be used, allowing the user to more easily see the work area.

### CROSS REFERENCE TO RELATED APPLICATION

This application claims the benefit of U.S. Provisional Application No. 62/038,987 filed on Aug. 19, 2014. The above identified patent application is herein incorporated by reference in its entirety to provide continuity of disclosure.

### BACKGROUND OF THE INVENTION

### FIELD OF THE INVENTION

The present invention relates to tools having integrated lights. More specifically, the present invention provides an illuminated ratchet wrench having an elongated handle and a tool head on which one or more pairs of lights are positioned. The lights are integrated into the tool head and are directed towards the area in which the ratchet wrench will be used.

Mechanics and other workers often use ratchet or socket wrenches and other tools in narrow or confined areas, such as areas under the hood of a vehicle, or areas on the undercarriage of a vehicle. As a result, these areas receive little light making it hard to see the area in which the user is trying to work. Further, it can be difficult to illuminate the narrow and confined areas due to a lack of space.

While some users may try to hold a flashlight in order to illuminate the area in which the user desires to work, holding a flashlight in one hand is inconvenient for the user, and the user may need both hands in order to complete a task. Moreover, the flashlight may not be able to properly illuminate the area when the user has his or her hands and tools in the same area. Thus, a socket wrench having integrated lights is desired in order to easily illuminate a work area.

Devices have been disclosed in the prior art that relate to wrenches having lights thereon. These include devices that have been patented and published in patent application publications. Such devices generally relate to ratchet wrenches of various construction having a light source thereon, such as U.S. Pat. No. 2,466,342, U.S. Pat. No. 4,324,158, U.S. Pat. No. 6,527,404, U.S. Pat. No. 5,848,832, and U.S. Pat. No. 6,283,606.

These prior art devices have several known drawbacks. The devices in the prior art disclose ratchet wrenches having lights thereon, but fail to disclose a ratchet wrench having a tool head with one or more pairs of lights on the lower portion thereof, wherein the lights are directed in the same direction as the socket head so as to illuminate the area engaged by the ratchet wrench. Some devices include a light source positioned directly on the socket head, however this provides a narrow of a field of illumination, and the illumination may be obscured or blocked once the socket head is engaged with a workpiece

In light of the devices disclosed in the prior art, it is submitted that the present invention substantially diverges in design elements from the prior art and consequently it is clear that there is a need in the art for an improvement to existing illuminated ratchet wrench devices. In this regard, the instant invention substantially fulfills these needs.

### SUMMARY OF THE INVENTION

In view of the foregoing disadvantages inherent in the known types of illuminated ratchet wrenches now present in the prior art, the present invention provides a new illuminated ratchet wrench wherein the same can be utilized for providing convenience for the user when illuminating a narrow or confined space to allow the user to more easily see the area in which he or she is working.

It is therefore an object of the present invention to provide a new and improved illuminated ratchet wrench device that has all of the advantages of the prior art and none of the disadvantages.

It is another object of the present invention to provide an illuminated ratchet wrench comprising an elongated handle and a tool head having a ratchet and one or more pairs of lights thereon, wherein the ratchet wrench functions similarly to a traditional ratchet wrench.

Another object of the present invention is to provide an illuminated ratchet wrench having one or more pairs of LED lights integrated into the tool head of the ratchet wrench.

Yet another object of the present invention is to provide an illuminated ratchet wrench having one or more pairs of LED lights disposed on the lower portion of the tool head adjacent to the handle so as to illuminate the area engaged by the socket head of the ratchet wrench.

Another object of the present invention is to provide an illuminated ratchet wrench that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the illuminated ratchet wrench of the present invention.

FIG. 2 shows an overhead view of an embodiment of the illuminated ratchet wrench of the present invention.

FIG. 3 shows a schematic diagram of the electrical components of the illuminated ratchet wrench.

### DETAILED DESCRIPTION OF THE INVENTION

Reference is made herein to the attached drawings. Like reference numerals are used throughout the drawings to depict like or similar elements of the illuminated ratchet wrench. For the purposes of presenting a brief and clear description of the present invention, the preferred embodiment will be discussed as used for illuminating a workpiece engaged by the illuminated ratchet wrench. The figures are intended for representative purposes only and should not be considered to be limiting in any respect.

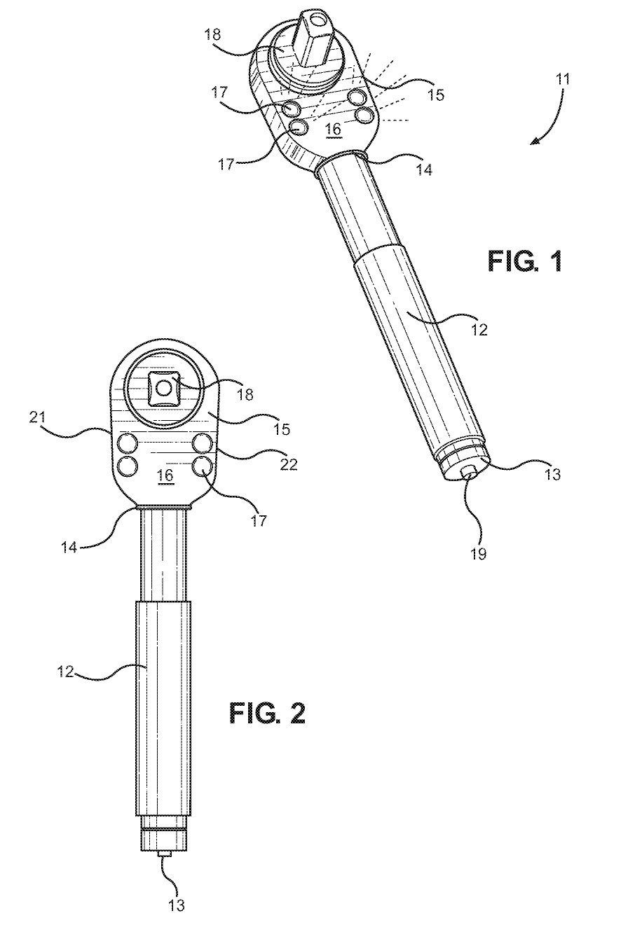

Referring now to FIGS. 1 and 2, there are shown views of embodiments of the illuminated ratchet wrench of the present invention. The illuminated ratchet wrench 11 comprises an elongated handle 12 having a first end 13 and a second end 14. The elongated handle 12 is preferably substantially linear in configuration. The handle 12 is shown as having a square cross sectional area, but may have a circular or other cross sectional area in alternate embodiments. The handle 12 may further include a high-friction surface so as to improve the user's ability to grip the same. Thus, the handle may have a rubberized grip thereon for providing a non-slip gripping area for a user to hold the tool, or may have a textured or knurled surface. Preferably, the illuminated ratchet wrench 11 is composed of metal, such as steel.

The second end 14 of the elongated handle 12 comprises a tool head 15 thereon. The tool head 15 comprises a front surface 16 having a socket head 18 thereon. The socket head 18 is rotatable via a ratcheting mechanism that allows the socket head 18 to rotate in only one direction. The socket head 18 includes a protruding element that preferably comprises a square cross section. Thus, the illuminated ratchet wrench 11 is constructed and operates similarly to a conventional ratchet wrench.

The illuminated ratchet wrench 11 includes one or more pairs of lights 17 on the front surface 16 thereof. In the illustrated embodiment, two pairs of lights 17 are shown. However, in alternate embodiments, one pair of lights, or three or more pairs of lights can be positioned on the tool head 15. The pairs of lights 17 are arranged on a lower portion of the tool head 15 in an area between the second end of the handle 14 and the socket head 18. In this way, the lights 17 are oriented in the same direction as the socket head 18 so as to illuminate the work piece to be contacted by the socket head 18. The lights 17 preferably comprise LEDs so as to provide high brightness with low power consumption. Further, LEDs are compact so as to not consume much space on the tool head 15.

The pairs of lights 17 are preferably arranged such that one light 17 is on the first side 21 of the front surface 16 tool head 15, while the other light 17 in the pair is located on the second side 22 of the front surface 16 of the tool head 15. In this way, the lights 17 can provide a wider field of illumination than centrally located lights 17. Preferably, the pairs of lights 17 are aligned with one another.

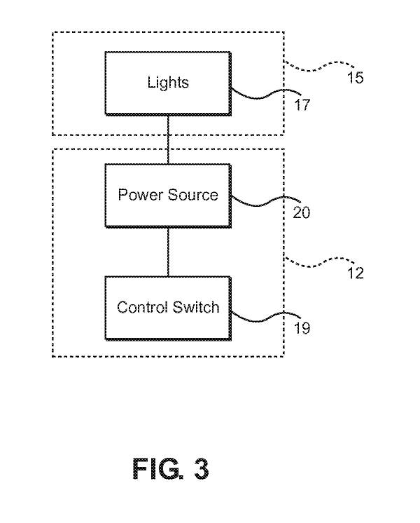

Referring now to FIG. 3, there is shown a schematic diagram of the electrical components of the illuminated ratchet wrench. The lights 17 disposed on the tool head 15 of the illuminated ratchet wrench are in electrical connection with a power source 20 and a control switch 19. The power source 20 and control switch 19 are preferably located on the handle 12 of the illuminated ratchet wrench. The control switch 20 is a push-button switch that serves to turn the lights 17 on or off. The control switch 20 is preferably located on the lower end of the handle 12 so as to not interfere with the gripping area of the handle 12. The power source 20 preferably comprises one or more batteries that can be positioned within the elongated handle 12. The batteries can be disposable or rechargeable. However, in alternate embodiments, other types of power sources are contemplated.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminated ratchet wrench, comprising:
an elongated handle having a first end and a second end;
a tool head having a front surface, wherein said tool head is disposed on said second end of said handle;
said tool head comprising a socket head and one or more pairs of lights.

2) The illuminated ratchet wrench of claim 1, wherein said elongated handle is substantially linear.

3) The illuminated ratchet wrench of claim 1, wherein said tool head comprises a first pair of lights and a second pair of lights.

4) The illuminated ratchet wrench of claim 1, wherein said one or more pairs of lights are LEDs.

5) The illuminated ratchet wrench of claim 1, wherein said one or more pairs of lights are oriented in the same direction as said socket head.

6) The illuminated ratchet wrench of claim 1, wherein said one or more pairs of lights are disposed on said front surface of said tool head in an area between said second end of said elongated handle and said socket head.

7) The illuminated ratchet wrench of claim 1, further comprising a power source adapted to provide power to said one or more pairs of lights.

8) The illuminated ratchet wrench of claim 1, further comprising a control switch adapted to allow a user to selectively illuminate said one or more pairs of lights.

9) The illuminated ratchet wrench of claim 1, wherein said elongated handle comprises a rubberized grip.

10) The illuminated ratchet wrench of claim 1, wherein said elongated handle comprises a textured surface.
